(19) United States
(12) Patent Application Publication
(10) Pub. No.: US 2014/0241375 A1
(43) Pub. Date: Aug. 28, 2014

(54) INDUSTRIAL AUTOMATION CONTROL COMMUNICATION METHOD AND APPARATUS

(71) Applicant: Toyota Motor Engineering & Manufacturing North America, Inc, (US)

(72) Inventors: Ramachandran Venkata Subramanian, Kitchener (CA); Graham Hancock, Hamilton (CA); Roger Ivan, Waterloo (CA); James Andrew Clark, St. George (CA)

(73) Assignee: Toyota Motor Engineering & Manufacturing North America, Inc, Erlanger, KY (US)

(21) Appl. No.: 13/778,915

(22) Filed: Feb. 27, 2013

(51) Int. Cl. H04L 12/56

(52) U.S. Cl. CPC H04L 49/30
USPC 370/419

(57) ABSTRACT

A control communication method and apparatus couples electrical outputs of devices directly to a network I/O module without connecting the devices to an electrical control system. The network I/O module includes outputs for sending control data received over an Ethernet network directly to a production device without intervening electrical control. The network I/O module transmits data identifying the device generating an output signal along with the network I/O module ID, over the Ethernet network in TCP/IP protocol.

### BACKGROUND

The present industrial automation control communication method and apparatus relates, in general, to industrial automation controls and, more particularly, for industrial automation controls connected to a local area network.

Industrial automation control systems, such as control systems for manufacturing automotive vehicles, interconnect control system components, such as automotive body assembly equipment, body conveyors or transfer systems, system indicators, switches, etc., at a plurality of work stations in an assembly plant into a large network with communication via high level communication protocols, such as Transfer Control Protocol/Internet Protocol (TCP/IP) to an assembly plant central computer or processor based system for remote monitoring and control throughout the assembly plant.

One or more workstations may include automated equipment for assembling components onto the vehicle body. A control system would be typically located in the workstation and dedicated to controlling the automated equipment. Such control systems take a variety of forms, including relay based systems, Programmable Logic Controllers (PLC), as well as other electronic or computer based control systems.

Such control systems are responsive to push buttons, switches, sensors and other inputs at the work station for activating outputs, such as pneumatic cylinders, welding equipment, linear actuators, etc., in accordance with the control program embedded in the relay wiring logic, the PLC control program, etc.

Certain workstation based push buttons, sensors or detection switches have been used to provide a plant wide alert outside of the workstation to call for additional parts, activate an alarm, stop the assembly line, call maintenance for repair, etc.

Since PLCs have network connection capability, through an Ethernet network I/O module or card, such area wide call buttons, alarm buttons, maintenance call buttons, and other sensors have been connected by wiring to the PLC.

Control logic embedded in the control program of the PLC is then used to activate the PLC network output to send the appropriate signal through the plant wide network to a processor based computer system for further action.

Since the area wide production switches or sensors are wired through existing work station or lineside controls, such as PLCs, significant effort is involved in connecting the call buttons sensors or switches to the plant wide communication network.

For example, coupling a single call button from one work station to the plant wide communication network to send a signal to the parts department to indicate that the particular work station needs additional parts, requires hard wiring the output of the call button to the control system, such as the PLC controlling the automation equipment at the particular workstation or other workstations. Due to the complexity of vehicle assembly operations, such control logic may be distributed over several different PLCs. The PLCs have a considerable cost which can easily exceed $10,000 per PLC for an enclosure, electrical power, control program development, installation, debugging, etc. Developing a control program for the PLC to control the automation equipment at a workstation as well as to handle the call buttons or other sensors which are to be connected to the plant wide communication network requires a high technical skill set. The PLC control program can easily be tampered with, accidentally overwritten, or even lost in the event of a failure. Installation or modification of the assembly line may encounter additional expense and significant effort for wiring and reprogramming of the PLC.

Thus, it would be desirable to provide an industrial automation control communication method and apparatus which addresses the problems encountered in connecting assembly line side call buttons, alarm buttons, or other sensors and signaling devices to a plant wide area communication network.

### SUMMARY

A control communication and interface apparatus includes a network I/O module directly connected to an electrical output of a device without intervening electrical control. The network I/O module is configured to transmit the electrical output of the device over an Ethernet network.

The module can include at least one output terminal for converting data transmitted over the Ethernet network to the network I/O module to an electrical output from the output terminal of the network I/O. Another production device is directly coupled, without intervening electrical control to the output terminal of the network I/O module for controlling another production device.

The network I/O module transmits data over the Ethernet network in TCP/IP protocol.

The apparatus includes a computer based supervisory server or processor coupled to the Ethernet network for receiving data transmitted by the network I/O module over the Ethernet network. The data transmitted by the network I/O module over the Ethernet network identifies the production sending an output device and the ID of the network I/O module.

In one aspect, an industrial automation control communication control apparatus includes a production device producing an electrical output and a network I/O module having a first terminal directly coupled to the electrical output of the production device without an intervening connection to an electrical control. The network I/O module is coupled to an Ethernet network and configured to transmit data over the Ethernet network identifying the electrical output of the production device.

The network I/O module can also include an output terminal. The network I/O module, in response to data received over the Ethernet network, is configured to energize the output terminal to control another production device directly coupled to the output terminal without an intervening connection to an electrical control.

A method for communicating electrical control data over a network includes coupling an electrical output of a device to an input terminal of a network I/O module without an intervening connection of the device to an electrical control system, coupling the network I/O module to an Ethernet network, and configuring the network I/O module to transmit data identifying the production device over the Ethernet network in response to detection of the electrical output of the production device at an input terminal of the network I/O module.

### BRIEF DESCRIPTION OF THE DRAWING

The various features, advantages and other uses of the present industrial automation control communication method and apparatus will become more apparent by referring to the following detailed description and drawing in which:

FIG. 1 is a block diagram of a plant network based control system which can utilize an industrial automation control communication method and apparatus;

FIG. 2 is a block schematic diagram of the components and interconnections of a call box shown in FIG. 1;

FIG. 3 is a partial wiring diagram for a network I/O module in the call box shown in FIGS. 1 and 2;

FIG. 4 is a circuit diagram of the electrical power connections for the network I/O module shown in FIG. 3;

FIGS. 5 and 6 are pictorial representations illustrating bidirectional data flow through the industrial automation control communication apparatus;

FIG. 7 is a schematic diagram of the input connections to the network I/O module shown in FIG. 4; and

FIG. 8 is a schematic diagram of the output connections to the network I/O module shown in FIG. 4.

### DETAILED DESCRIPTION

The present method and apparatus will be described in conjunction with an automotive vehicle assembly production line. It will be understood that the present method and apparatus can be used in other applications without departing from the examples of the method and apparatus described hereafter.

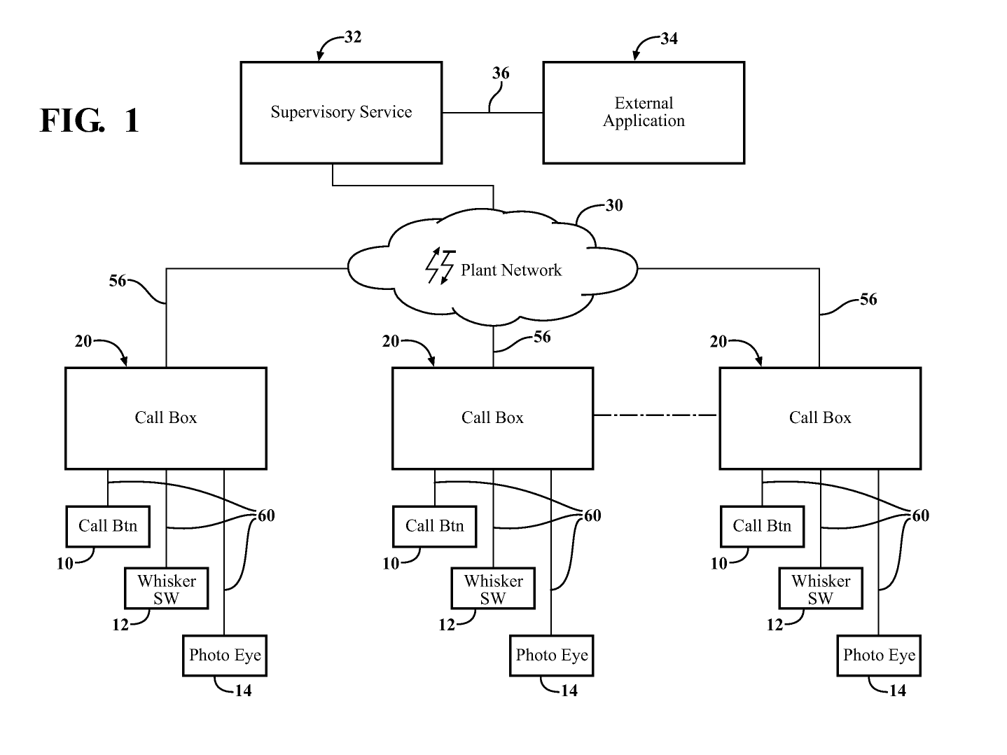

As shown in FIG. 1, the present method and apparatus is employed, by example, in an automotive vehicle assembly line in conjunction with a parts or automotive component call and conveyance system. Generally, such a call system employs sensors, manual push buttons, switches or other signaling devices which generate an output or change states at the occurrence of a particular detected event. Thus, as shown in FIG. 1, the call system employs a plurality of call push buttons 10 that are manually operated by an operator in a workstation to place a call for additional automotive components or parts. Similarly, a whisker switch or a proximity switch 12 and a photo-eye cell or sensor 14 can be employed with automatic parts accumulation and delivery systems at various locations or workstations in the assembly plant to detect the absence of sufficient parts to continue the vehicle assembly process.

In each instance, the signaling device, whether it be the push button 10, the whisker switch 12 or the photo-eye cell 14, sends an electrical output defined by a change in state of the electrical device output to one or more call boxes 20 located at different locations throughout the assembly plant.

The electrical output from the signaling devices 10, 12, and 14 may be any type of electrical output such as, for example, an automotive production automation control system output that changes voltage and/or current depending upon an open or closed position of an associated device sensor or actuator, a digital signal that switches between 0 and 1 states, a normally closed switch contact that changes to an open state when the signaling device 10, 12 or 14 is actuated, or the contact is a normally open contact which changes to a closed state when the actuator of the signaling device 10, 12 or 14 is actuated.

Each call box 20 functions to identify the output from one particular signaling device 10, 12, or 14 and convert the output to a communication protocol or format suitable for transmission over a plant network communication system 30 to a supervisory service 32. The supervisory service 32 may constitute a computing device or system containing multiple computing devices, such as a desktop computer, a server, etc. The computing device in a supervisory service 32, in the present example, is in the form of a central processing unit based server accessing an operating system and application programs stored in a memory which permit the central processing unit to perform the methods described hereafter.

In general, the supervisory service 32, or server, identifies an output from one of the signaling devices 10, 12, and 14, transmitted by the network I/O module 50, and passes the output identifying the particular signaling device 10, 12, or 14, to an external application 34 through a network 36.

The external application 34 may also be a central processor based computing device executing an application program stored in a memory. In the present example, the external application 34 can be a server or computer device in a parts conveyance department responsible for conveying new parts or automotive components to the particular location where the output from one of the signaling devices 10, 12, or 14 is located.

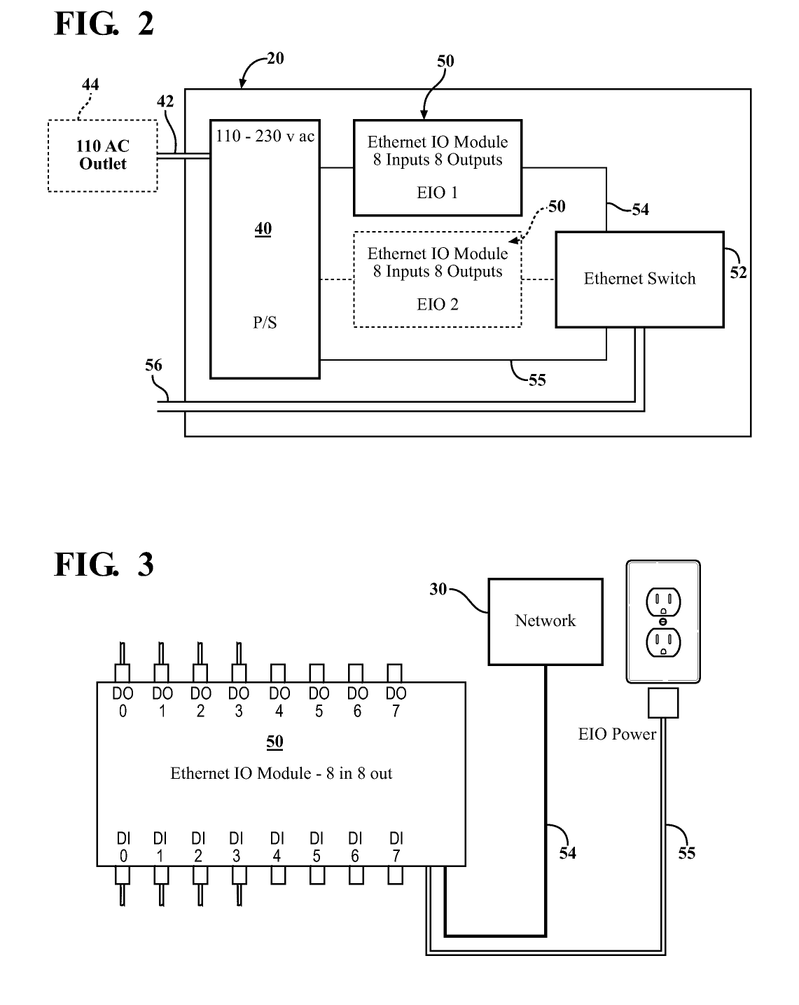

As shown in FIGS. 2-7, each call box 20 includes an industrial rated enclosure mounted in a particular location in the assembly plant typically nearby one or more of the signaling devices 10, 12, and 14. The call box 20 includes a power supply 40 coupled by conductors 42 to a source of 110/230 VAC power 44. The power supply 40 converts the input A/C power to low level DC power, such as 24 volt DC power, which is supplied to one or more network I/O modules 50 as well as to a network switch, such as an Ethernet switch 52. Each network I/O module 50 is coupled to the Ethernet switch 52 by an Ethernet cable 54, which can be a cable, a coax pair of wires, multi-conductors, etc. The output 56 of the Ethernet switch 52 is coupled to the plant wide network for transmission to the supervisory service 32.

Other networks, such as token ring, etc. can also be used instead of an Ethernet network.

By example, the network I/O module 50 in the call box 20 can be an Athreya Inc. AI-EIO-8I8O 8 Input and 8 Output Ethernet I/O module. One or more network I/O modules can be provided in a single enclosure.

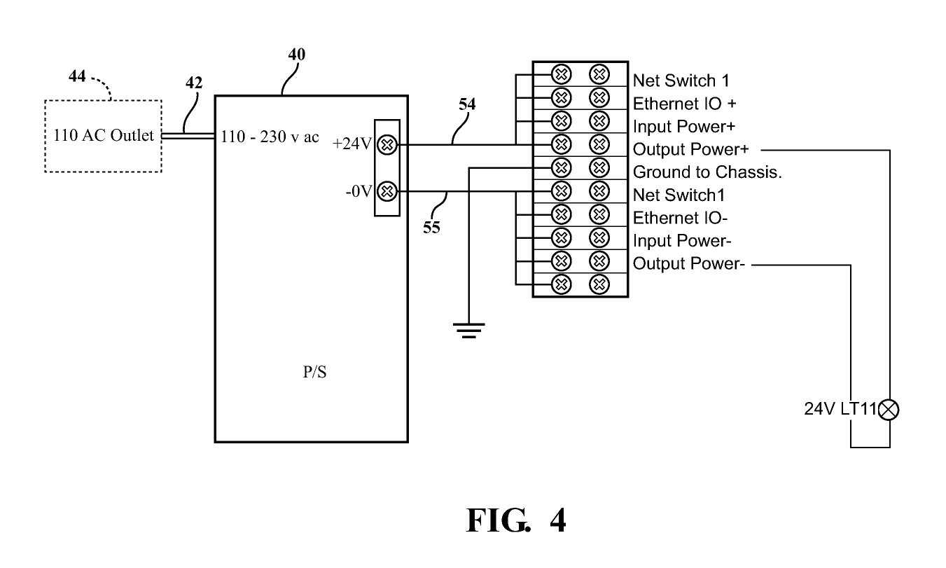

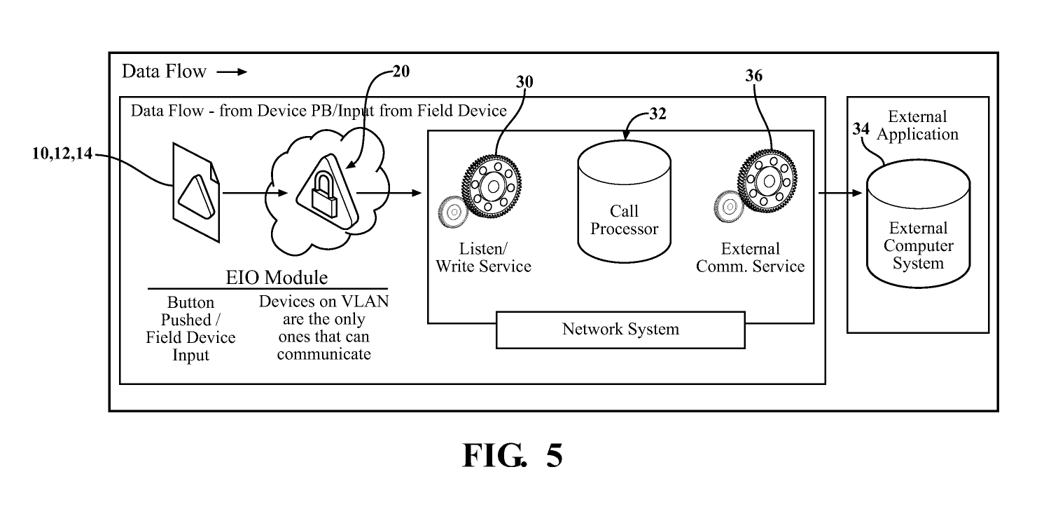

As shown in FIGS. 3 and 4, the network I/O module 50 includes 8 inputs DI0-DI7 and 8 outputs DO0 to DO7 as well as power and ground connections. The input and outputs of the network I/O module 50 can be any type of input and output termination or connector including a plug-in jack, a hardwired electrical terminal, or combinations thereof.

Each input DI0-DI7 may be directly connected to one input signaling device 10, 12, or 14 without intervening electrical control, that is, without connecting the signaling device 10, 12, or 14 to an electrical control system. Similarly, each output DO0-DO7 can be directly connected to a separate output device. The network I/O module 50 serves to receive the outputs of the call devices 10, the whisker switch 12 and/or the photo-eye or cell 14 and to transmit data through the cable 54 to the Ethernet switch 52 and then onto the network 56 identifying a MAC ID of the particular network I/O module 50 as well as the input pin number DI0-DI7 for the signaling device output in question in native TCP/IP protocol for communication to the supervisory service or server 32 via the plant network 30. Native TCP/IP protocol also includes the use of other industrial protocols in conjunction with TCP/IP protocol.

Similarly, the network I/O module 50 functions to receive data transmissions in a reverse direction from the network 56 through the Ethernet switch 52 for changing the state of any of the outputs DO0-DO7.

Direct connection, as described above, of the input signaling devices 10, 12, and 14 to the network I/O module 50 in the call box 20 as well as the connection of any output DO0-DO7 of the network I/O module 50 in the call box 20 with an external device means the direct connection of the input or output device to the network I/O module 50 input or output terminals without intervening electrical control. In the present example, the input signaling devices 10, 12, and 14 have their outputs coupled directly to an input terminal DI0-DI7 in one network I/O module 50 in one call box 20 without any intervening connections to an electrical control apparatus, such as a relay based control system, a PLC control system, or other electronic or computer based control systems, which use an input terminal and signal conditioning card or circuit to receive the output of the input signaling device 10, 12, and 14 and convert the output to a data signal used by the control program executed by the control system to control the state of an output of the control system. In the case of a relay based control system, intervening electric control means that the output of the signaling device is coupled to a relay or relays which, according to the particular wiring ladder logic, control the state of at least one other relay in the control system. The output of the at least one other relay is then coupled to an external device or application.

“Without intervening electrical control” does not exclude the connection of the output of a signaling device 10, 12, and 14 via a pig tail or other hardwire connections to an intervening junction box where a terminal connection receives the input from the signaling device 10, 12, and 14 and is then electrically connected via a terminal and hardwire conductors, cables, etc. to another junction box or to the network I/O module 50 in one call box 20.

In the present industrial automation control communication method and apparatus, the electrical output of each signaling device 10, 12, and 14 is supplied directly, in its native electrical voltage and current output state to an input terminal DI0-DI7 on one network I/O module 50.

The same direct connection without intervening electrical control applies equally to the devices coupled to the output terminals DO0-DO7. This means that the output voltage and current supplied by the network I/O module 50 through an output termination DO0-DO7 to an output device, such as one light 68, is directly connected to the output device without intervening electrical control logic in a wired relay control system or in a PLC, electronic or other computer based control system.

As shown in FIG. 4, the power supply 40 is coupled through wiring 53 and 55 to each network I/O module 50 as well as to the Ethernet switch 52, respectively.

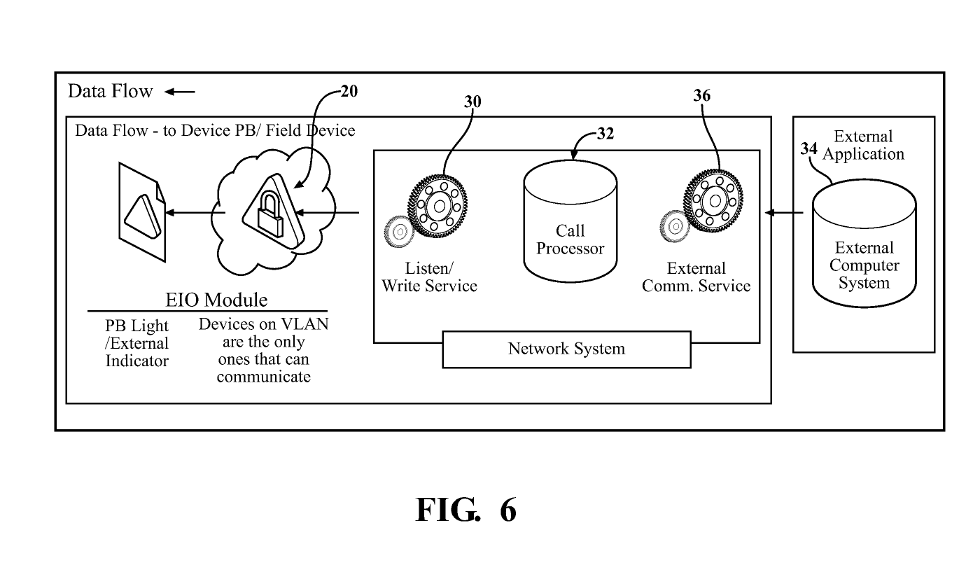

This bidirectional flow through the call box 20 is shown in FIGS. 5 and 6. In FIG. 5, depicted data flow from the signaling devices 10, 12, and 14 through the call box 20 to the supervisory service 32 or server and then to the external application 34. In FIG. 6, a reverse data flow sequence is shown from the external application 34 through the network 36 to the supervisory service 32 or server and then through the plant network 30 and one call box 20 to at least one or a plurality of output devices described hereafter.

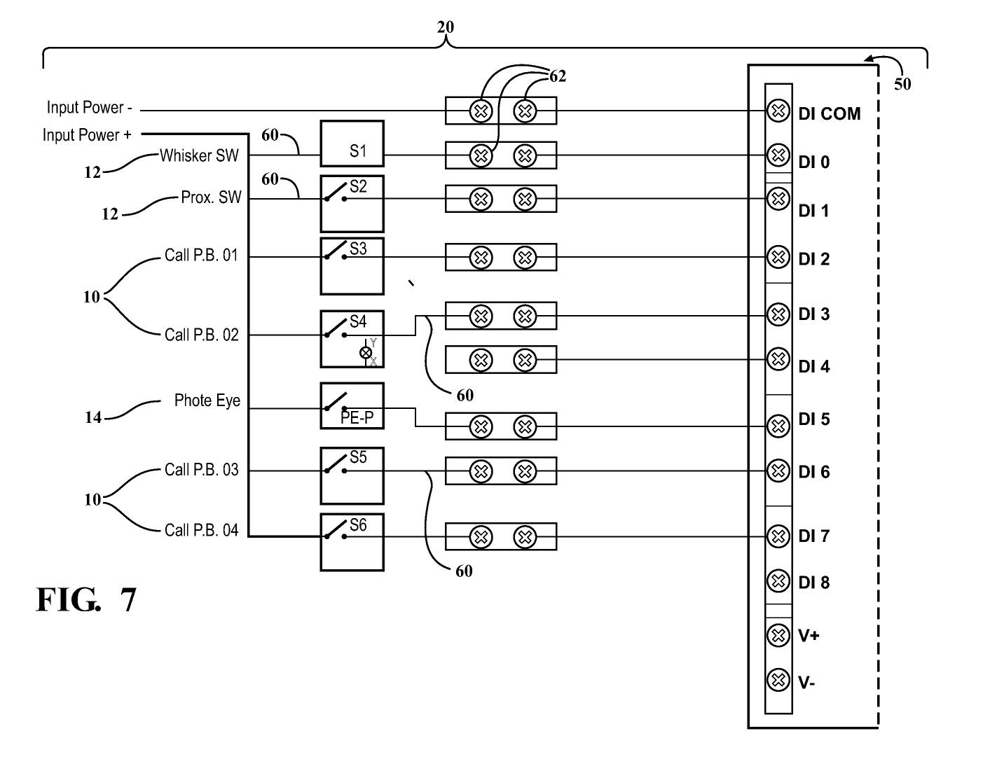

FIG. 7 depicts an example of various inputs that can be connected to the input terminal connections DI0-DI7 of the network I/O module 50 in one call box 20. For example, the whisker switch 12 or a proximity switch 12, as well as separate call push buttons 10, depicted in an electrical schematic switch format, are coupled by electrical conductors 60 to terminals 62 in the call box 20.

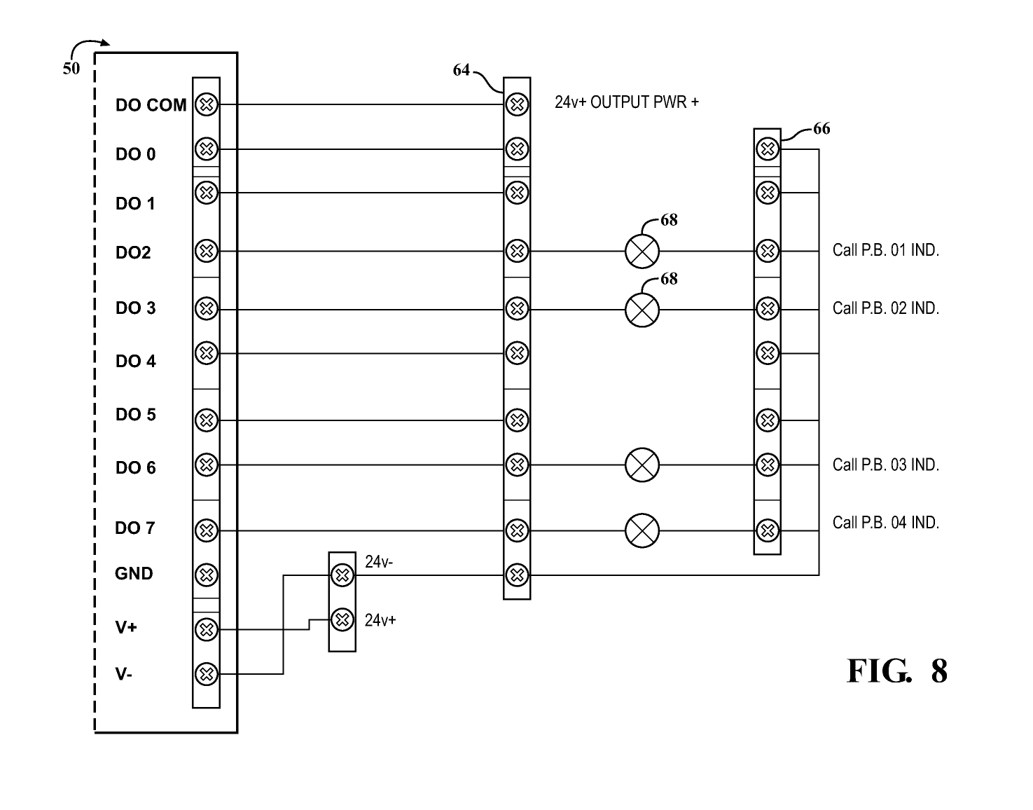

The terminals 62 are wired to one of the input terminals DI0-DI7 on the network I/O module 50. Although hardwired conductors may be used to connect each signaling device 10, 12, 14 to the terminals 62 in the call box 20, the call box 20 may be provided with five pin receptacles which receive a pigtail extending for each signaling device 10, 12 and 14 and carrying a five pin plug at one end for easy connection of the signaling devices 10, 12, and 14 to the terminals 62 in the call box 20. Each five-pin receptacle mounted on the enclosure of the call box 20 has its internal connections wired to the terminals 62 as shown in FIG. 7 or 8. Similarly, as shown in FIG. 8, each output terminal DO0-DO7 can be prewired to terminal 64. The terminals 64 and 66 can be coupled to two selected conductors in a five pin receptacle associated with a particular call push button 10 to control the illumination state of a light 68 in the call push button 10.

By way of example in the present implementation, the light 68 is integral with the call push button 10 and is used to provide an indication to the worker whether or not and when a call has been received and the current action being taken with respect to the call. For example, when sufficient parts present at a particular workstation, the light 68 associated with one call push button 10 will be off. When the worker depresses the call push button 10 to place a call for additional parts, the output from the call push button 10 is transmitted to the call box 20. The call box 20 converts the electrical signal from the call push button 10 into native TCP/IP protocol for transmission via the network 56 and the plant network 30 to the supervisory service 32 or server. The supervisory service 32 or server, according to its application program, notices the change of state of the call push button 10 and sends the signal via the network 36 to the external application 34 which is programmed to respond to the call push button signal

In the present example, the parts conveyance department, either manually or automatically via its own computer based processor, can send a return data transmission through the supervisory service 32 or server and the plant network 30 to the call box 20 which converts the data to an output DO0-DO7—connected to the light 68 associated with a particular call push button 10 that originated the call sequence. The external application 34, for example, can cause the light 68 to blink indicating that the parts call has been received, but not yet assigned to a conveyance vehicle or driver, or turn the light 68 on steadily to indicate that the parts are being conveyed to the workstation.

The call box 20 provides an inexpensive connection point for the various signaling devices, and converts the electrical DC outputs of the signaling devices to native TCP/IP protocol format for transmission via the Ethernet network and the plant network to a supervisory service or server 32 which identifies the particular input and sends the input identification onto an external application 34 for taking action according to the application program of the external application 34.

What is claimed is:

1. A communication interface apparatus comprising:
a network I/O module directly connected to an electrical output of a device without an intervening connection to an electrical control system; and
the network I/O module configured to transmit data identifying the device over an Ethernet network.

2. The communication interface apparatus of claim 1 further comprising:
the network I/O module having at least one output terminal, the network I/O module configured to convert data transmitted over the Ethernet network to an electrical output from the output terminal.

3. The communication interface apparatus of claim 1 wherein:
the network I/O module transmits data natively over the Ethernet network in TCP/IP protocol.

4. The communication interface apparatus of claim 1 wherein:
the data transmitted by the network I/O module over the Ethernet network identifies the output received from the device and an identification of the network I/O module.

5. The communication interface apparatus of claim 1 further comprising:
a computer based supervisory device coupled to the Ethernet network and receiving data transmitted by the network I/O module over the Ethernet network;
the computer based supervisory device executing program instructions to transmit data received from the network I/O module to an external application.

6. The communication interface apparatus of claim 1 wherein the device comprises:
a production device producing a changeable state electrical output.

7. The communication interface apparatus of claim 6 further comprising:
the network I/O module having at least one output terminal; and
another production device directly coupled without an intervening connection to an electrical control system, to the output terminal of the network I/O module for controlling another production device.

8. An industrial automation communication interface apparatus comprising:
a production device producing an electrical output;
a network I/O module having an input terminal directly coupled to the electrical output of the production device without an intervening connection to an electrical control system; and
the network I/O module coupled to an Ethernet network, the network I/O module configured to transmit data over the Ethernet network identifying the electrical output of the production device.

9. The industrial automation communication interface apparatus of claim 8 further comprising:
the network I/O module having an output terminal; and
the network I/O, in response to data received from the Ethernet network, configured to activate the output terminal to control another production device directly coupled, without an intervening connection to an electrical control system, to the output terminal.

10. A method for communicating electrical control data over a network comprising:
connecting an electrical output of a device to an input terminal of a network I/O module without connecting the device to an electrical control system;
coupling the network I/O module to an Ethernet network; and
configuring the network I/O module to transmit data identifying the device over the Ethernet network in response to the electrical output of the device.
